(19) United States
(12) Patent Application Publication
(10) Pub. No.: US 2025/0222442 A1
(43) Pub. Date: Jul. 10, 2025

(54) ORGANO-TEMPLATE FREE FER SYNTHESIS

(71) Applicant: JOHNSON MATTHEY PUBLIC LIMITED COMPANY, London (GB)

(72) Inventors: Ugursan AYDOGAN, Reading Berkshire (GB); Alexander Nicholas Michael GREEN, Royston Hertfordshire (GB); Agnes RAJ, Reading Berkshire (GB); Alessandro TURRINA, Billingham Cleveland (GB); Logan SPELL, Savannah, GA (US)

(21) Appl. No.: 18/848,734

(22) PCT Filed: May 17, 2023
(86) PCT No.: PCT/GB2023/051294

§ 371 Date: Sep. 19, 2024

Related U.S. Application Data
(60) Provisional application No. 63/364,826, filed on May 17, 2022.

(51) Int. Cl. B01J 29/65; B01D 53/94; B01J 35/61; B01J 35/63; B01J 35/77; B01J 37/00; B01J 37/04; B01J 37/06; B01J 37/08; B01J 37/30; C01B 39/02; C01B 39/44

(52) U.S. Cl. CPC B01J 29/65; B01D 53/9418; B01D 53/9431; B01J 35/615; B01J 35/633; B01J 35/77; B01J 37/009; B01J 37/04; B01J 37/06; B01J 37/088; B01J 37/30; C01B 39/026; C01B 39/44; B01D 2255/50; B01D 2255/9205; B01D 2255/9207; B01D 2257/404; B01D 2258/01; C01P 2002/60; C01P 2002/72; C01P 2002/86; C01P 2004/03; C01P 2006/12; C01P 2006/14

(57) ABSTRACT

An organo-template free method for the manufacture of a ferrierite (FER) zeolite and the ferrierite producible by the method. The method comprises (i) forming a reaction gel comprising an aluminium source, sodium and/or potassium hydroxide, and silica sol; and (ii) heating the reaction gel to a temperature and for a duration suitable for the growth of the FER zeolite. The reaction gel does not comprise seed crystals. Moreover the reaction gel does not comprise an organic structure directing agent (OSDA). The ferrierite (FER) zeolite has the following features: a) a SAR of between 11 and 20; b) a BET surface area of between 320 and 380 m²/g; and c) a micropore volume of between 0.1 and 0.2 cm³/g.

### FIELD OF THE INVENTION

The present invention relates to a ferrierite (FER) zeolite. The present invention also relates to a method for the manufacture of a ferrierite zeolite. The present invention further relates to a catalyst article comprising a ferrierite zeolite and a method for the treatment of an exhaust gas which comprises contacting an exhaust gas with a catalyst article comprising a FER zeolite.

### BACKGROUND OF THE INVENTION

Zeolites are crystalline or quasi-crystalline aluminosilicates constructed of repeating TO₄ tetrahedral units with T being most commonly Si, and Al (or combinations of tetrahedral units). These units are linked together to form frameworks having regular cavities and/or channels of molecular dimensions within the crystal. Numerous types of synthetic zeolites have been synthesized and each has a unique framework based on the specific arrangement its tetrahedral units. By the IUPAC nomenclature, each topological type is assigned a unique three-letter code (e.g., “FER”) by the International Zeolite Association (IZA) (http://www.iza-structure.org/databases/).

Zeolites have numerous industrial applications, and zeolites of certain frameworks, such as FER, are known to be effective catalyst for treating combustion exhaust gas in industrial applications including internal combustion engines, gas turbines, coal-fired power plants, and the like. In one example, nitrogen oxides (NOₓ) in the exhaust gas may be controlled through a so-called selective catalytic reduction (SCR) process whereby NOₓ compounds in the exhaust gas are contacted with a reducing agent in the presence of a zeolite catalyst.

Synthetic zeolites of the FER topological type when prepared as aluminosilicate compositions are generally produced using structure directing agents (SDAs), also referred to as a “templates” or “templating agents”. The SDAs that are used in the preparation of aluminosilicate FER topological type materials are typically complex organic molecules which guide or direct the molecular shape and pattern of the zeolite's framework. Generally, the SDA can be considered as a mold around which the zeolite crystals form. After the crystals are formed, the SDA is removed from the interior structure of the crystals, leaving a molecularly porous aluminosilicate cage.

In typical synthesis techniques, solid zeolite crystals are formed from a reaction mixture which contains the framework reactants (e.g., a source of silica and a source of alumina), a source of hydroxide ions (e.g., NaOH), and an SDA. Such synthesis techniques usually take several days (depending on factors such as crystallization temperature) to achieve the desired crystallization. When crystallization is complete, the solid product containing the zeolite crystals is separated from the mother liquor which is discarded. This discarded mother liquor contains unused SDA, which is often degraded due to harsh reaction conditions, and unreacted silica.

SDAs for use in FER zeolite synthesis are relatively expensive and contribute to a substantial portion of the cost of manufacturing the zeolite, as well as producing a large amount of waste. In addition, conventional methods for synthesizing zeolite FER have a relatively poor yield based on the SDA (a key component of the reaction mixture) which also impacts manufacturing costs.

Various prior art documents disclose the organic structure directing agent (OSDA)-free synthesis of FER, but use zeolite seeds to assist in the synthesis (see Chemical Engineering & Technology, 2002, 25, 273; JACS, 2012, 134, 11542; Microporous and Mesoporous Materials, 2014, 196, 89; and Journal of Materials Chemistry, 2011, 21, 9494). Other methods use templates to make FER (see WO 2020/021054 and Microporous and Mesoporous Materials, 2020, 296, 109988). U.S. Pat. No. 4,650,654 discloses the synthesis of a FER zeolite without using organic mineralizing agents and without using aqueous colloidal silica as the silica source. However, FER made by these methods do not exhibit improved catalytic performance.

The inventors have discovered that compared to the prior art, the FER zeolite formed by the present invention has improved catalytic performance. Without being bound by theory, it is thought that the specific method of preparing the FER as outlined herein allows control of the Al distribution in the FER framework and consequently positively impacts the Fe speciation by promoting monomeric and dimeric active species.

There remains a need in the art of improved FER zeolites with improved catalytic performance, such as improved NOx conversion. In addition, it would be desirable to reduce the cost of the synthesis process, preferably by a means that has a low impact on the environment. This invention satisfies these needs amongst others.

### SUMMARY OF THE INVENTION

One aspect of the present disclosure is directed to a ferrierite (FER) zeolite having the following features:
a) a SAR of between 11 and 20;
b) a BET surface area of between 320 and 380 m²/g;
c) a micropore volume of between 0.1 and 0.2 cm³/g.

Another aspect of the present disclosure is directed to an organo-template free method for the manufacture of a ferrierite (FER) zeolite, the method comprising:
(i) forming a reaction gel comprising an aluminium source, sodium and/or potassium hydroxide, and silica sol,
(ii) heating the reaction gel to a temperature and for a duration suitable for the growth of the FER zeolite,
   wherein the reaction gel does not comprise seed crystals, and further wherein the reaction gel does not comprise an organic structure directing agent (OSDA).

Another aspect of the present disclosure is directed to a catalyst article for the treatment of an exhaust gas, the catalyst article comprising the FER zeolite as described herein or obtainable by the method as described herein.

Another aspect of the present disclosure is directed to a method for the treatment of an exhaust gas, the method comprising contacting an exhaust gas with the catalyst article described herein.

### BRIEF DESCRIPTION OF THE DRAWINGS

FIG. 1 shows a powder X-ray diffraction (XRD) patterns of the H-form FER structures made in Examples 2 and 7 and Comparative Examples CE2 and CE3.

FIG. 2 shows scanning electron micrograph (SEM) of H-FER from Example 2.

FIG. 3 shows ²⁷Al solid-state MAS NMR for H-form FER sample from Example 2.

FIG. 4 shows NOx conversion for the fresh and aged iron FER sample (H-form Example 2) compared to that of Comparative Example CE2 for the Selective Catalytic Reduction (SCR) of NOx.

FIG. 5 shows NOx conversion for the fresh and aged iron FER sample (H-form Example 7) compared to that of Comparative Example CE3 for the Selective Catalytic Reduction (SCR) of NOx.

### DETAILED DESCRIPTION OF THE INVENTION

A first aspect of the present invention is directed to a ferrierite (FER) zeolite having the following features:
a) a SAR (SiO₂/Al₂O₃) of between 11 and 20;
b) a BET surface area of between 320 and 380 m²/g; and
c) a micropore volume of between 0.1 and 0.2 cm³/g.

The present disclosure will now be described further. In the following passages, different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

The FER zeolite according to the invention can be a hydrogen-form (H-form) FER zeolite. The term “H-form” of a FER zeolite refers to a FER zeolite with the framework charge substantially balanced by protons. In this form, the FER zeolite generally contains a mixture of H⁺ and alkali and/or alkaline earth cations in the exchange sites. The H-form of a FER zeolite can be ≥90%, ≥95%, ≥96%, ≥97%, 98%, or ≥99% (by weight) in H-form. The amount of the FER zeolite in H-form can vary depending on the specific FER zeolite batch and the method used to form the FER zeolite.

Preferably, the FER zeolite of the present invention has a SAR of at most 20, preferably at most 19, preferably at most 18, more preferably at most 17 and even more preferably at most 16. It is also preferred in some embodiments that the CHA zeolite has an SAR of at least 11 or at least 12. In some embodiments, it is preferred that the CHA zeolite has an SAR of from 11 to 20, 12 to 19, 13 to 18, 14 to 17 or from 15 to 16, e.g. from 11 to 19, 11.5 to 17.5, or 12 to 17.

As used herein, the SAR (SiO₂/Al₂O₃) refers to the synthesized zeolite crystal and not to the starting synthesis gel. The SAR of the zeolites can be determined by conventional analysis. This ratio is intended to be as close as possible to the ratio in the rigid atomic framework of the zeolite crystal and to exclude silicon or aluminum in the binder or in cationic or other form within the channels. Since it may be difficult to directly measure the silica to alumina ratio (SAR) of the zeolite after it has been combined with a binder material, particularly an alumina binder, these silica to alumina ratios will be relative to the SAR zeolite per se, i.e., prior to combining the zeolite with the other catalyst components.

In combination with the desired SAR, the present invention can provide a FER zeolite having a BET surface area of 320 to 380 m²/g; preferably, 330 to 375 m²/g, e.g. from 340 to 370 m²/g; 345 to 365 m²/g, 348 to 364 m²/g. 349 to 363 m²/g, 350 to 360 m²/g, 351 to 359 m²/g, 352 to 358 m²/g or 353 to 357 m²/g.

In combination with the desired SAR, the present invention can provide a FER zeolite having a micropore volume of 0.1-0.2 cm³/g; preferably 0.11-0.18 cm³/g; or more preferably, 0.11-0.15 cm³/g, e.g. from 0.11 to 0.14 cm³/g or from 0.12 to 0.13 cm³/g. In a further embodiment, the micropore volume of the FER zeolite is 0.12 cm³/g.

Alone or in combination with any of the desired features as described herein, the present invention can provide a FER zeolite having a mesopore volume of from 0.01 to 0.1 cm³/g, preferably from 0.015 to 0.08 cm³/g, more preferably from 0.02 to 0.05 cm³/g, from 0.025 to 0.045 cm³/g, e.g. from 0.03 to 0.04 cm³/g. In a preferred embodiment, the mesopore volume is from 0.01 to 0.06 cm³/g, e.g. from 0.015 to 0.05 cm³/g.

Alone or in combination with any of the desired features as described herein, the present invention can provide a FER zeolite having an external surface area of less than 35 m²/g, preferably no greater 30 m²/g, more preferably no greater than 25 m²/g. In some embodiments, the FER zeolite can have a external surface area of no greater than 24 m²/g, no greater than 22 m²/g, no greater than 21 m²/g, no greater than 20 m²/g, no greater than 19 m²/g, no greater than 18 m²/g, no greater than 17 m²/g, no greater than 16 m²/g, no greater than 15 m²/g, no greater than 14 m²/g, no greater than 12 m²/g or no greater than 10 m²/g. In certain embodiments, the FER zeolite can have a external surface area of 0-35 m²/g, 1-30 m²/g, 2-25 m²/g, or 3-24 m²/g, 4-22 m²/g, 5-20 m²/g, 6-18 m²/g, 7-17 m²/g, 8-15 m²/g or 9-12 m²/g, e.g. from 8 to 25 m²/g, e.g. from 9 to 20 m²/g, from 10 to 19 m²/g, from 11 to 18 m²/g, from 12 to 17 m²/g, or from 13 to 16 m²/g. In a preferred embodiment, the external surface area is from 10 to 20 m²/g.

The external surface area may be measured using any conventional technique in the art. For example, by measuring the Ar or N₂ adsorption isotherms on the activated samples at 87 or 77 K, respectively, according to the Brunauer-Emmett-Teller (BET) method. Prior to measurement the samples are heated under vacuum to remove physiosorbed water. The pore size distributions are measured by the nonlocal density functional theory (NLDFT). The external surface area is calculated by the difference between the apparent BET and the micropore surface areas.

Preferably, the FER zeolite has a crystallinity of greater than 95%, e.g. greater than 97% or greater than 98%. The FER zeolite can be substantially free of other crystalline phases and typically it is not an intergrowth of two or more framework types. As used herein, the term “substantially free” means that the zeolite contains less than about 5, 4, 3, 2, 1, 0.5, 0.1, 0.05, 0.01 weight percent of the named framework impurity or of all the impurities.

Preferably, the FER zeolite has a flake-like morphology. That is, it is preferred that the zeolite has a morphology whereby the zeolite crystals have a substantially planar or one dimensional shape, or disk or plate like particles having a two dimensional shape, in contrast to particles having a three-dimensional shape.

Preferably, the FER zeolite has a mean longest edge crystal size of no greater than 1 micron, preferably, no greater than 0.9 microns. In some embodiments, the FER zeolite can have a mean longest edge crystal size of 0.01-1 microns, e.g. 0.1-0.9 microns, 0.2-0.8 microns, 0.25-0.7 microns, 0.3-0.6 microns, or 0.4-0.5 microns. Such an average crystal size may be determined using standard microscopic techniques such as scanning electron microscopy (SEM). The measurement is taken over a statistically meaningful portion of the zeolites produced.

In a further embodiment, the 6-fold Al is less than or equal to 15%, e.g. less than 15%, less than 14%, less than 12%, less than 10%. In some embodiments, the 6-fold Al is from 3 to 15%, from 3.5 to 14%, from 4 to 13%, from 5 to 12%, from 6 to 10%. The 6-fold Al can be determined using standard techniques, such as ²⁷Al solid state MAS-NMR. The spectra can be quantified by integrating over the ranges of 80 ppm to −30 ppm to cover all observed isotropic peaks and 15 ppm to −30 ppm to cover only the 6-fold Al. The measurements can be taken on the hydrogen-form FER zeolite.

In a preferred embodiment, the FER zeolite according to the invention is free or substantially free from one or more of the following: fluorine, fluorine-containing compounds and fluorine ions. Preferably, FER zeolite according to the invention is free or substantially free from all of the following: fluorine, fluorine-containing compounds and fluorine ions. By “substantially free from”, it is meant that the zeolite contains less than 0.1%, e.g. less than 0.08%, less than 0.05%, less than 0.03%, less than 0.02%, less than 0.01%, less than 0.005%, less than 0.001% (by weight based on the total weight of the zeolite) of the undesired components.

In a further aspect of the present invention, there is provided a method for the manufacture of a ferrierite (FER) zeolite, the method comprising:
(i) forming a reaction gel comprising an aluminium source, sodium and/or potassium hydroxide, and silica sol,
(ii) heating the reaction gel to a temperature and for a duration suitable for the growth of the FER zeolite,
wherein the reaction gel does not comprise seed crystals, and further wherein the reaction gel does not comprise an organic structure directing agent (OSDA).

It is particularly preferred that the method described herein is for making the FER zeolite described herein.

The method for preparing ferrierite can comprise forming a reaction gel which may also simply be referred to as a reaction mixture. Such reaction gels are well known in the art of zeolite synthesis.

The reaction gel for the method of preparing ferrierite comprises an aluminium source, sodium/potassium hydroxide and a silica sol. Examples of aluminium sources include sodium aluminate, aluminium salts such as aluminium sulfate, aluminum nitrate, aluminum chloride, aluminium hydroxide, aluminium alkoxides, and alumina, preferably one or more of sodium aluminate and aluminium hydroxide. Silica sol is a colloidal suspension of silica in water. In a preferred embodiment, the reaction gel comprises sodium aluminate, sodium hydroxide and silica sol solution.

As is known in the art, the reaction composition may be described in terms of the equivalent amount of SiO₂, Al₂O₃, M₂O (where M is an alkali metal or alkaline earth metal), and H₂O present in the reaction gel. In other words, the reaction gel composition may be described by the ratio: Al₂O₃: aSiO2 bM₂O: cH₂O wherein the reaction composition is normalised to a molar amount (1 mole) of Al₂O₃ equivalent. As will be appreciated, the scale of the reaction and the absolute number of moles may vary.

In some embodiments, the M₂O equivalent, that is the total amount of all M₂O equivalents (e.g. there could be one or both of Na₂O and K₂O present), relative to the molar amount of Al₂O₃ equivalent, is at least 1 mole, preferably from 1 to 10 moles, more preferably from 2 to 8 moles, more preferably from 2.2 to 6 moles. Equally, it may be said that “b” in the gel composition may be any of these ranges or values. In some particularly preferred embodiments, the amount of M₂O equivalent, relative to the molar amount of Al₂O₃ equivalent in the reaction gel is from 1 to 8 moles. Where lower amounts of M₂O equivalent are preferred, the amount of M₂O equivalent is preferably from 1.5 to 7 moles, preferably from 2 to 6 moles. M can be selected from one or more alkali metals or alkaline earth metals. Preferably, M is selected from one or more from the list comprising (e.g. consisting of): Na, K, Li, Cs, Sr and Ba. In a preferred embodiment, M is Na.

In some embodiments, it is preferred that, relative to the molar amount of Al₂O₃ equivalent, the gel comprises an amount of SiO₂ equivalent of at least 10 moles, preferably 10 to 50 moles, 12 to 40 moles, or 13 to 35 moles. Equally, it may be said that “a” in the gel composition may be any of these ranges or values. For example, in some embodiments, higher amounts of SiO₂ equivalent are preferred such as from 14 to 33 moles, preferably from 15 to 30 moles, or from 20 to 25 moles. In some preferred embodiments, about 20 moles of SiO₂ equivalent are preferred.

In some embodiments, it is preferred that, relative to the molar amount of Al₂O₃ equivalent, the gel comprises water and the water is present in an amount of at least 700 moles, preferably 750 to 4000 moles. Equally, it may be said that “c” in the gel composition may be any of these ranges or values. For example, in some embodiments, higher amounts of water are preferred (in particular where higher amounts of SiO₂ equivalent or M₂O equivalent are added) such as from 800 to 3000 moles, preferably from 900 to 1250 moles, such as about 1000 moles.

In some embodiments, the reaction gel composition has a Na₂O/SiO₂ ratio of from 0.05 to 0.3, e.g. from 0.06 to 0.25, 0.07 to 0.22, 0.08 to 0.2, 0.09 to 0.19, 0.1 to 0.18, 0.11 to 0.17, 0.12 to 0.16, 0.13 to 0.17 or 0.14 to 0.16. In a preferred embodiment, the Na₂O/SiO₂ ratio is from 0.08 to 0.21, 0.09 to 0.2, or 0.1 to 0.18.

In some embodiments, the reaction gel composition has a K₂O/(K₂O+Na₂O) ratio of less than 0.1, e.g. less than 0.099, less than 0.095, less than 0.09, less than 0.08, less than 0.07. In some embodiments, the reaction gel has a K₂O/(K₂O+Na₂O) ratio of from 0 to 0.099, from 0.01 to 0.095 or from 0.015 to 0.09.

In some embodiments, the reaction gel composition has a H₂O/SiO₂ ratio of from 45 to 110, e.g. from 50 to 100.

The reaction gel for preparing ferrierite is an organic structure directing agent-free gel, i.e. the reaction gel does not comprise an organic structure directing agent (OSDA). By “does not comprise an organic structure directing agent”, it is meant that the reaction gel comprises less than 1 wt % of an organic structure directing agent, e.g. less than 0.9 wt %, less than 0.5 wt %, less than 0.3 wt %, less than 0.2 wt %, less than 0.1 wt % or less than 0.01 wt % of an organic structure directing agent, based on the total weight of the reaction gel. In a preferred embodiment, the reaction gel comprises 0 wt % of an organic structure directing agent.

A particular advantage of the present method is that the inventors have found that the method does not require the use of seed crystals so as to form the desirable FER zeolite. Accordingly, the reaction gel does not comprise seed crystals (e.g. FER seed crystals). By “does not comprise seed crystals”, it is meant that the reaction gel comprises less than 0.1% seed crystals, e.g. less than 0.08%, less than 0.05%, less than 0.03%, less than 0.02%, less than 0.01%, less than 0.005%, less than 0.001% seed crystals, based on the total weight of the reaction gel. In a preferred embodiment, the reaction gel comprises 0 wt % seed crystals.

In a preferred embodiment, the rection gel is free or substantially free from one or more of the following: fluorine, fluorine-containing compounds, and fluorine ions. Preferably, the reaction gel is free or substantially free from all of the following: fluorine, fluorine-containing compounds and fluorine ions. By “substantially free from”, it is meant that the zeolite contains less than 0.1%, e.g. less than 0.08%, less than 0.05%, less than 0.03%, less than 0.02%, less than 0.01%, less than 0.005%, less than 0.001% (by weight based on the total weight of the zeolite) of the undesired components.

In one particular preferred embodiment of the present invention, the reaction gel consists of an aluminium source, sodium hydroxide, silica sol, and water, and, optionally, a further sodium and/or potassium salt.

Heating the reaction gel for the preparation of ferrierite is performed at a temperature and for a duration suitable for the growth of the FER zeolite. Preferably, the temperature to which the reaction gel is heated for such a suitable duration is from 100° C. to 220° C.; more preferably from 110° C. to 210° C., 120° C. to 200° C., 130° C. to 190° C., or even 140° C. to 180° C. The duration for which the reaction gel is heated to a suitable temperature, is preferably at least 10 hours, more preferably, 20 hours to 8 days, 1 day to 7 days, e.g., 1 to 6 days. It is particularly preferred that the reaction gel is heated to these temperatures and held at these temperatures for these durations, e.g. for at least 10 hours at a temperature of from 100° C. to 220° C.

Preferably, the FER zeolite product resulting from heating the reaction gel for such a temperature and duration is recovered by typical vacuum filtration. Preferably, the filtered product is washed with demineralized (also known as deionized) water is used to remove residual mother liquor. Preferably, the zeolite product is washed until the filtrate conductivity is below 0.1 mS. Preferably, the filtered and washed product is then dried at temperatures of greater than 100° C., preferably about 120° C. The FER zeolite product can be filtered by vacuum filtration and washed with demineralized water.

The method of the present invention may further comprise one or more steps to remove metal ion such as an alkali metal ion from within the FER ion exchange site. Typically, the alkali metal ion is exchanged with a non-metal cation such as an ammonium ion (NH₄⁺) or a proton (H⁺). Ion exchange to an ammonium ion may be performed by mixing the zeolite into an ammonium sulphate aqueous solution followed by stirring. Furthermore, ion exchange to a proton may be performed by ion-exchanging the zeolite with ammonia and calcining it preferably in an oxygen containing environment, such as in air, at a temperature of about 450 to 600° C., preferably about 500-550° C., for a period from about 25-40 hours, for example from about 30 to 35 hours.

FER zeolite of the present invention can be used as a catalyst and/or adsorbent. In a preferred example, one or more catalytically active metals or metals that otherwise improve the performance of a catalyst composition (collectively, “enhancing metal”) is exchanged into the FER zeolite. The exchange of enhancing metals can be accomplished post zeolite synthesis via incipient wetness, solid state ion exchange, or during the preparation of a washcoat slurry, or in-situ during the synthetization step by the addition of the enhancing metal(s) into the reaction mixture. Any one of the abovementioned metals can be used in combination with any of the other methods, for example, to incorporate two or more enhancing metals into the zeolite.

Preferably, the enhancing metals are non-framework metals. As used herein, a “non-framework metal” is a metal that resides within the zeolite pores and/or on at least a portion of the zeolite surface, preferably as an ionic species, does not include aluminum, and does not include atoms constituting the framework of the zeolite. Preferably, the presence of an enhancing metal(s) facilitates the treatment of exhaust gases, such as exhaust gas from a diesel engine, including processes such as NOₓ reduction, NH₃ oxidation, and NOₓ storage.

Enhancing metals include certain transition metals, such as copper (Cu), iron (Fe), manganese (Mn), nickel (Ni), molybdenum (Mo), and zinc (Zn), with copper and/or iron being preferred and copper being most preferred. Certain enhancing metals are precious metals, such as gold (Au) and silver (Ag), and also platinum group metals such as platinum (Pt), palladium (Pd), ruthenium (Ru), and rhodium (Rh). Additionally, enhancing metals can be one or more rare earth metals such as cerium (Ce), praseodymium (Pr), neodymium (Nd), europium (Eu), erbium (Er), gadolinium (Gd), ytterbium (Yb), and yttrium (Y) which can be used to improve catalytic performance, particularly when used in combination with a transition metal. (Although yttrium can be described as a transition metal, it is referred to herein as a rare earth metal due to its lanthanide-like properties.)

The one or more enhancing metals are preferably present at a concentration of about 0.1 to about 10 weight percent (wt. %) based on the total weight of the zeolite, for example from about 0.5 wt % to about 5 wt. %, from about 0.5 to about 1 wt. %, about 1 to about 1.5 wt. %, about 1 to about 2 wt. %, from about 1 to about 5 wt. %, about 2.5 wt. % to about 3.5 wt. %, and from about 3.5 to about 5 wt. %. For embodiments which utilized two or more enhancing metals, each metal independently can be present in the abovementioned amounts.

When copper, iron, or the combination thereof are used as enhancing metals, they are preferably present at a concentration of these transition metals in FER zeolite material of about 1 to about 5 weight percent, more preferably about 2.5 to about 4.5 weight percent based on the total weight of FER zeolite.

In a further embodiment, the method for preparing ferrierite can further comprise a step of loading iron onto the FER zeolite formed in step ii) by ion exchange, e.g. by using an iron source, for example an iron source selected from iron (II) chloride or ferric ammonium oxalate. For example, the method for preparing ferrierite can further comprise step iii) loading iron onto the FER zeolite by ion exchange with an iron source selected from iron (II) chloride or ferric ammonium oxalate.

In a further embodiment, the ferrierite zeolite as described herein or as obtained from the method as described herein can be present in a catalyst composition.

The catalyst composition can contain noble metals, such as, Pt, Pd, Ru, Rh, Os, Ir, Ag, or Au. In other embodiments, the catalyst composition can be essentially free of any precious metals.

Alternatively, the catalyst composition may be essentially free of precious metals except palladium, platinum, and rhodium, essentially free of precious metals except palladium and platinum, or essentially free of precious metals except palladium.

The catalyst composition can be essentially free of any non-framework transition metal. Alternatively, the catalyst composition may be essentially free of non-framework transition metals except copper and iron. In certain examples, the catalyst is essentially free of any non-framework transition metal except copper.

In a further aspect of the present invention, there is provided a catalyst article for the treatment of an exhaust gas, the catalyst article comprising the FER zeolite as described herein. The catalyst article can comprise the FER zeolite as described herein disposed on and/or within a substrate. The substrate can be a metal plate or a honeycomb. The FER zeolite as described herein can be a washcoat on the substrate, e.g. a honeycomb. The honeycomb can be an extruded catalyst, a wall-flow filter or a flow-through honeycomb.

In yet a further aspect, there is provided a method for the treatment of an exhaust gas, the method comprising contacting an exhaust gas with the catalyst article described herein. The method for treating an exhaust gas can further comprise contacting an exhaust gas containing NOₓ and/or NH₃ with a catalyst article described herein to selectively reduce at least a portion of the NOₓ into N₂ and H₂O and/or oxidize at least a portion of the NH₃. Thus, in one embodiment, the catalyst article can be formulated to favor the reduction of nitrogen oxides with a reductant (i.e., an SCR catalyst). Examples of such reductants include hydrocarbons (e.g., C₃-C₆ hydrocarbons) and nitrogenous reductants such as ammonia and ammonia hydrazine or any suitable ammonia precursor, such as urea ((NH₂)₂CO), ammonium carbonate, ammonium carbamate, ammonium hydrogen carbonate or ammonium formate.

Preferably, the catalyst has a low N₂O selectivity. N₂O selectivity is defined as the moles N₂O formed divided by the moles of NOₓ (NOₓ defined as NO and NO₂) converted. Lower N₂O selectivity is desired because of the need to reduce N₂O formation.

The method for the treatment of an exhaust gas can comprise a method for the reduction of NOₓ compounds or oxidation of NH₃ in a gas, which comprises contacting the gas with a catalyst article comprising the FER zeolite as described herein for the catalytic reduction of NOₓ compounds for a time sufficient to reduce the level of NOₓ compounds and/or NH₃ in the gas. In certain embodiments, provided is a catalyst article (e.g. a catalyst article comprising the FER zeolite as described herein) having an ammonia slip catalyst disposed downstream of a selective catalytic reduction (SCR) catalyst. In such embodiments, the ammonia slip catalyst oxidizes at least a portion of any nitrogenous reductant that is not consumed by the selective catalytic reduction process. For example, in certain embodiments, the ammonia slip catalyst is disposed on the outlet side of a wall flow filter and an SCR catalyst is disposed on the upstream side of a filter. In certain other embodiments, the ammonia slip catalyst is disposed on the downstream end of a flow-through substrate and an SCR catalyst is disposed on the upstream end of the flow-through substrate. In other embodiments, the ammonia slip catalyst and SCR catalyst are disposed on separate bricks within the exhaust system. These separate bricks can be adjacent to, and in contact with, each other or separated by a specific distance, provided that they are in fluid communication with each other and provided that the SCR catalyst brick is disposed upstream of the ammonia slip catalyst brick.

In certain embodiments, the SCR and/or AMOX process is performed at a temperature of at least 150° C. In another embodiment, the process(es) occur at a temperature from about 160° C. to about 750° C. In a particular embodiment, the temperature range is from about 175 to about 550° C. In another embodiment, the temperature range is from 175 to 400° C. In yet another embodiment, the temperature range is 450 to 900° C., preferably 500 to 750° C., 500 to 650° C., 450 to 550° C., or 650 to 850° C. Embodiments utilizing temperatures greater than 450° C. are particularly useful for treating exhaust gases from a heavy and light duty diesel engine that is equipped with an exhaust system comprising (optionally catalyzed) diesel particulate filters which are regenerated actively, e.g. by injecting hydrocarbon into the exhaust system upstream of the filter, wherein the FER zeolite as described herein (or a catalyst article comprising the FER zeolite as described herein) is located downstream of the filter.

According to another aspect of the invention, provided is a method for the reduction of NO_{X} compounds and/or oxidation of NH₃ in a gas, which comprises contacting the gas with a catalyst article comprising the FER zeolite as described herein for a time sufficient to reduce the level of NO_{X} compounds in the gas. Methods of the present invention may comprise one or more of the following steps: (a) accumulating and/or combusting soot that is in contact with the inlet of a catalytic filter; (b) introducing a nitrogenous reducing agent into the exhaust gas stream prior to contacting the catalytic filter, preferably with no intervening catalytic steps involving the treatment of NOₓ and the reductant; (c) generating NH₃ over a NOₓ adsorber catalyst or lean NOₓ trap, and preferably using such NH₃ as a reductant in a downstream SCR reaction; (d) contacting the exhaust gas stream with a DOC to oxidize hydrocarbon based soluble organic fraction (SOF) and/or carbon monoxide into CO₂, and/or oxidize NO into NO₂, which in turn, may be used to oxidize particulate matter in particulate filter; and/or reduce the particulate matter (PM) in the exhaust gas; (e) contacting the exhaust gas with one or more flow-through SCR catalyst device(s) in the presence of a reducing agent to reduce the NOx concentration in the exhaust gas; and (f) contacting the exhaust gas with an ammonia slip catalyst, preferably downstream of the SCR catalyst to oxidize most, if not all, of the ammonia prior to emitting the exhaust gas into the atmosphere or passing the exhaust gas through a recirculation loop prior to exhaust gas entering/re-entering the engine.

In another embodiment, all or at least a portion of the nitrogen-based reductant, particularly NH₃, for consumption in the SCR process can be supplied by a NO_{X} adsorber catalyst (NAC), a lean NO_{X} trap (LNT), or a NO_{X} storage/reduction catalyst (NSRC), disposed upstream of the SCR catalyst, e.g., a SCR catalyst of the present invention disposed on a wall-flow filter. NAC components useful in the present invention include a catalyst combination of a basic material (such as alkali metal, alkaline earth metal or a rare earth metal, including oxides of alkali metals, oxides of alkaline earth metals, and combinations thereof), and a precious metal (such as platinum), and optionally a reduction catalyst component, such as rhodium. Specific types of basic material useful in the NAC include cesium oxide, potassium oxide, magnesium oxide, sodium oxide, calcium oxide, strontium oxide, barium oxide, and combinations thereof. The precious metal is preferably present at about 10 to about 200 g/ft³, such as 20 to 60 g/ft³. Alternatively, the precious metal of the catalyst is characterized by the average concentration which may be from about 40 to about 100 grams/ft³.

Under certain conditions, during the periodically rich regeneration events, NH₃ may be generated over a NOₓ adsorber catalyst. The SCR catalyst downstream of the NOₓ adsorber catalyst may improve the overall system NOₓ reduction efficiency. In the combined system, the SCR catalyst is capable of storing the released NH₃ from the NAC catalyst during rich regeneration events and utilizes the stored NH₃ to selectively reduce some or all of the NOₓ that slips through the NAC catalyst during the normal lean operation conditions.

The method for treating exhaust gas as described herein can be performed on an exhaust gas derived from a combustion process, such as from an internal combustion engine (whether mobile or stationary), a gas turbine and coal or oil fired power plants. The method may also be used to treat gas from industrial processes such as refining, from refinery heaters and boilers, furnaces, the chemical processing industry, coke ovens, municipal waste plants and incinerators, etc. In a particular embodiment, the method is used for treating exhaust gas from a vehicular lean burn internal combustion engine, such as a diesel engine, a lean-burn gasoline engine or an engine powered by liquid petroleum gas or natural gas.

In a further aspect of the invention, there is provided a system for treating an exhaust gas containing NOx, the system comprising a catalyst article described herein and a source of a reductant, wherein the reductant source is upstream of the catalyst article.

In certain aspects, the system is for treating exhaust gas generated by combustion process, such as from an internal combustion engine (whether mobile or stationary), a gas turbine, coal or oil fired power plants, and the like. Such systems include a catalyst article comprising the FER zeolite as described herein and at least one additional component for treating the exhaust gas, wherein the catalyst article and at least one additional component are designed to function as a coherent unit. In certain embodiments, the system comprises a catalyst article comprising the FER zeolite as described herein, a conduit for directing a flowing exhaust gas, a source of nitrogenous reductant disposed upstream of the catalyst article. The system can include a controller for the metering the nitrogenous reductant into the flowing exhaust gas only when it is determined that the zeolite catalyst is capable of catalyzing NOₓ reduction at or above a desired efficiency, such as at above 100° C., above 150° C. or above 175° C. The metering of the nitrogenous reductant can be arranged such that 60% to 200% of theoretical ammonia is present in exhaust gas entering the SCR catalyst calculated at 1:1 NH₃/NO and 4:3 NH₃/NO₂.

In another embodiment, the system comprises an oxidation catalyst (e.g., a diesel oxidation catalyst (DOC)) for oxidizing nitrogen monoxide in the exhaust gas to nitrogen dioxide can be located upstream of a point of metering the nitrogenous reductant into the exhaust gas. In one embodiment, the oxidation catalyst is adapted to yield a gas stream entering the SCR zeolite catalyst having a ratio of NO to NO₂ of from about 4:1 to about 1:3 by volume, e.g. at an exhaust gas temperature at oxidation catalyst inlet of 250° C. to 450° C. The oxidation catalyst can include at least one platinum group metal (or some combination of these), such as platinum, palladium, or rhodium, coated on a flow-through monolith substrate. In one embodiment, the at least one platinum group metal is platinum, palladium or a combination of both platinum and palladium. The platinum group metal can be supported on a high surface area washcoat component such as alumina, a zeolite such as an aluminosilicate zeolite, silica, non-zeolite silica alumina, ceria, zirconia, titania or a mixed or composite oxide containing both ceria and zirconia.

In a further embodiment, a suitable filter substrate is located between the oxidation catalyst and the SCR catalyst. Filter substrates can be selected from a wall-flow filter, a flow-through filter, particulate filter, a catalytic filter, preferably a wall flow filter. Where the filter is catalyzed, e.g. with an oxidation catalyst, preferably the point of metering nitrogenous reductant is located between the filter and the zeolite catalyst. Alternatively, if the filter is un-catalyzed, the means for metering nitrogenous reductant can be located between the oxidation catalyst and the filter.

### EXAMPLES

### Examples 1 to 8 and Comparative Examples 1 to 3

The synthesis gel was prepared by first dissolving the aluminium source such as sodium aluminate (52.75% Al₂O₃, 42.47% Na₂O, 4.70% H₂O) and/or aluminium hydroxide (55.80% Al₂O₃) in sodium hydroxide (50.0% water solution) and deionized (DI) water. When required, potassium was added using potassium hydroxide (45.0% water solution) and/or potassium sulphate (99%) as raw materials. The silica sol (40% SiO₂) was then added to the sodium aluminate solution last, under vigorous agitation. The gel compositions are listed in Table 1. For crystallization, the gel was heated at 180° C. for 1-6 days at 200-400rpms. After crystallization, the solid phase was filtered, washed thoroughly with DI water, and dried at 120° C. To obtained the H-form of FER zeolite, the sample was ion exchanged at 100° C. using a 5% ammonia sulfate solution and then activated at 550° C. for two hours with a ramp rate of 1° C. per minute.

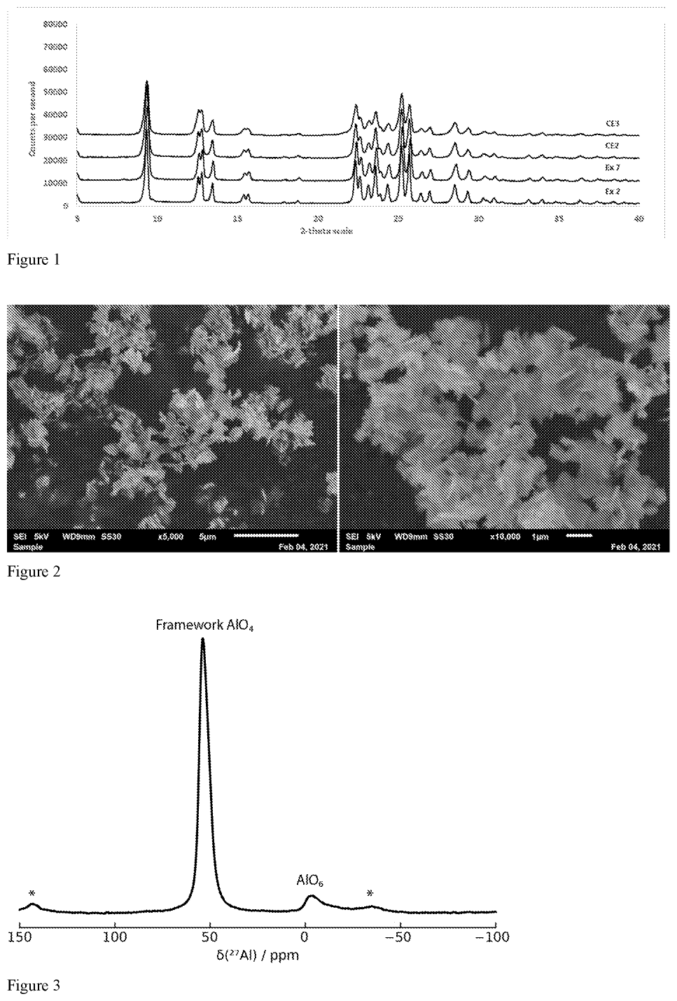

Each product was analysed by powder XRD and SEM. The powder XRD for H-form FER zeolite from Examples 2 and 7 and Comparative Examples CE2 and CE3 are shown in FIG. 1. An SEM image of the product from Example 2 is shown in FIG. 2. The ²⁷Al-solid-state MAS-NMR spectrum for H-form FER zeolite from Example 2 is shown in FIG. 3. SAR determined by X-ray fluorescence spectroscopy (XRF) and BET, external surface area, micro and meso pore volumes determined by Ar adsorption Isotherm are listed in Table 1.

TABLE 1
summary of examples 1-8 and comparative examples 1-3.

| | Synthesis conditions | | | | | Product | | | | |
|---|---|---|---|---|---|---|---|---|---|---|
| | | | | | | | | External | | |
| | | | | | Cryst | | | surface | Micropore | 6-fold |
| | Gel composition^{a} | | | | Time^{c} | | BET^{e} | area^{e} | Volume^{e} | Al^{f} |
| Example | SiO₂ | Na₂O | K₂O | H₂O | (h) | SAR^{d} | (m² g⁻¹) | (m²/g) | (cm³/g) | (%) |
| Ex1 | 15 | 2.30 | 0.2 | 1000 | 67 | 12.8 | — | — | — | — |
| Ex2^{b} | 20 | 2.67 | — | 1000 | 140 | 16.2 | 354 | 11 | 0.13 | 12 |
| Ex3 | 20 | 3.30 | — | 1000 | 67 | 16.5 | — | — | — | — |
| Ex4 | 20 | 3.00 | — | 1000 | 67 | 16.7 | — | — | — | — |
| Ex5 | 25 | 3.50 | — | 1250 | 67 | 19.5 | — | — | — | — |
| Ex6 | 30 | 6.00 | — | 3000 | 67 | 19.5 | — | — | — | — |
| Ex7^{b} | 25 | 3.33 | — | 1250 | 46 | 19.8 | 356 | 19 | 0.12 | — |
| Ex8 | 25 | 3.04 | — | 1250 | 67 | 20.0 | — | — | — | — |
| CE1^{b} | 15 | 2.50 | 2.50 | 750 | 42 | 12.1 | 350 | 16 | 0.12 | — |
| CE2 | 20 | 1.33 | 1.33 | 1000 | 92 | 16.3 | 353 | 23 | 0.12 | — |
| CE3 | 20 | 2.67 | 2.67 | 1000 | 62 | 19.9 | 363 | 22 | 0.13 | — |

^{a}All molar quantities as a ratio to 1.0 Al₂O₃.
^{b}Prepared using sodium aluminate instead of aluminum hydroxide as aluminum source.
^{c}All syntheses carried out at 180° C.
^{d}Determined by XRF.
^{e}Determined by Ar adsorption at 87K. Micropore volume, BET/external surface area assessed by t-plot method and Rouquerol optimisation method, respectively.
^{f}Determined by integrating the 27Al solid state MAS-NMR over the ranges of 80 ppm to −30 ppm to cover all observed isotropic peaks and 15 ppm to −30 ppm to cover only the 6-fold Al.

### Example 2: Selective Catalytic Reduction (SCR) Performance

H-forms FER zeolite from Examples 2 and 7 and Comparative Examples CE2 and CE3 were impregnated using the required amount of ferric ammonium oxalate dissolved in de-mineralized water. The Fe impregnated zeolite was dried overnight at 100° C. and then calcined in N₂ and H₂O at temperature between 50° and 700° C. for 1 hour. Iron in this case, was added to the zeolite to achieve a FER having 3.0 wt. % iron based on the total weight of the zeolite.

A portion of each iron FER zeolite samples was hydrothermally aged at 650° C. for 50 hours in air with 10% H₂O by volume.

Pelletized fresh and aged samples of the iron FER zeolites were placed in a test rig. To assess the zeolite's SCR performance over a range of temperatures, the zeolite was subjected to a flow of simulated diesel engine exhaust gas having the following properties: 525 ppm NH₃, 500 ppm NO, 12% O₂, 5% H₂O, 200 ppm CO and 4.2% CO₂, SV=60 K h⁻¹. The sample was exposed to the above-mentioned gas mix at 150° C. and the NOx conversion and N₂O selectivity were measured at various steady state temperatures 150-450° C.

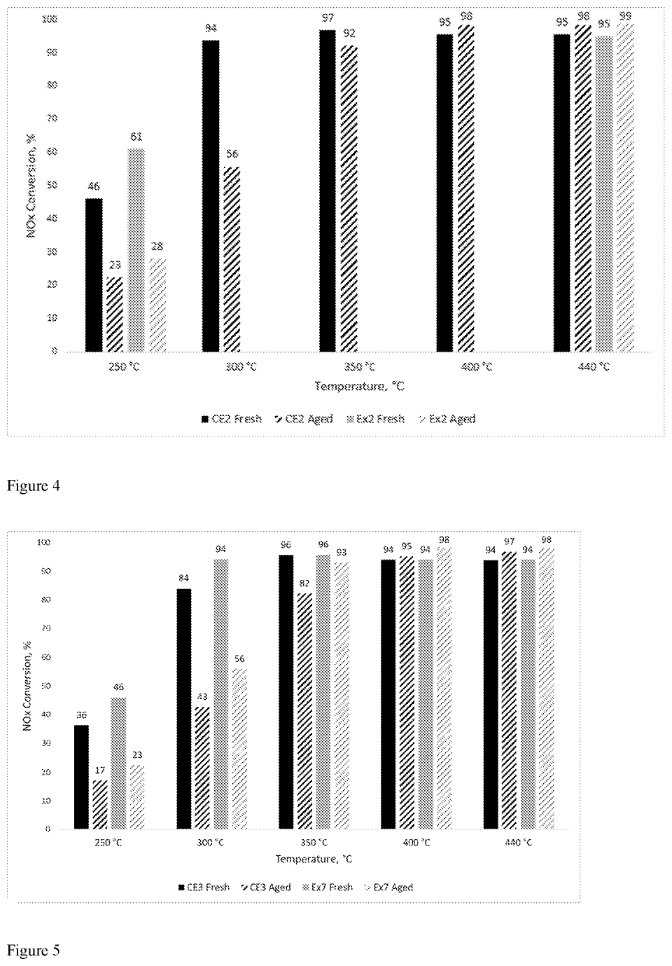

As shown in both FIG. 4 and FIG. 5, the fresh iron FER from Examples 2 and 7 achieved a significant higher NOₓ conversion in the temperature range between 250-300° C. compared to the two Comparative Examples 2 and 3 with similar SAR. The higher NOx conversion in the temperature range between 250-350° C. for the two FER samples from Example 2 and 7 is also achieved after the samples have been hydrothermally aged.

### Example 3—Solid State NMR

Solid state NMR spectra were acquired at a static magnetic field strength of 14.1 T (v₀(¹H)=600 MHz) on a Bruker Advance Neo console using TopSpin 4.0 software. Prior to measurement, zeolite samples were stored overnight in a humid environment. Powdered samples were packed into zirconia MAS rotors with Kel-F caps. The rotor was spun using room-temperature purified compressed air. The spinning frequency was 14 kHz with recycle delay of 0.4 s. The spectra were quantified by integrating over the ranges of 80 ppm to −30 ppm, covering all observed isotropic peaks, and 15 ppm to −30 ppm, covering only the six-coordinated AlO₆.

1. A ferrierite (FER) zeolite having the following features:
a) a SAR of between 11 and 20;
b) a BET surface area of between 320 and 380 m²/g; and
c) a micropore volume of between 0.1 and 0.2 cm³/g.

2. The FER zeolite according to claim 1, wherein the SAR is from 11 to 18, preferably from 12 to 17.

3. The FER zeolite according to claim 1, wherein the BET surface area is between 347 to 355 m²/g, preferably 348 to 352 m²/g.

4. The FER zeolite according to claim 1, wherein the micropore volume is 0.12 cm³/g.

5. The FER zeolite according to claim 1, wherein the zeolite has a crystallinity of greater than 95%.

6. The FER zeolite according to claim 1, wherein the zeolite has a crystal size of no greater than 1 micron, preferably, no greater than 0.9 microns.

7. The FER zeolite according claim 1, wherein the 6-fold Al is less than or equal to 15%.

8. The FER zeolite according to claim 1, wherein the external surface area is less than or equal to 20 m²/g.

9. An organo-template free method for the manufacture of a ferrierite (FER) zeolite, the method comprising:
(i) forming a reaction gel comprising an aluminium source, sodium and/or potassium hydroxide, and silica sol,
(ii) heating the reaction gel to a temperature and for a duration suitable for the growth of the FER zeolite,
wherein the reaction gel does not comprise seed crystals, and further wherein the reaction gel does not comprise an organic structure directing agent (OSDA).

10. The method according to claim 9, wherein the temperature of step (ii) is from 100° C. to 200° C., preferably from 110° C. to 190° C.

11. The method according to claim 9, wherein the duration of step (ii) is at least 20 hours, preferably from 1-6 days.

12. The method according to claim 9, wherein the reaction gel composition has a K₂O/(K₂O+Na₂O) ratio of less than 0.1.

13. The method according to claim 9 for making a ferrierite (FER) zeolite having the following features:
a) a SAR of between 11 and 20;
b) a BET surface area of between 320 and 380 m²/g; and
c) a micropore volume of between 0.1 and 0.2 cm³/g.

14. A catalyst article for the treatment of an exhaust gas, the catalyst article comprising a ferrierite (FER) zeolite having the following features:
a) a SAR of between 11 and 20;
b) a BET surface area of between 320 and 380 m²/g; and
c) a micropore volume of between 0.1 and 0.2 cm³/g.

15. The catalyst article according to claim 14 wherein the FER zeolite is disposed on and/or within a substrate.

16. A method for the treatment of an exhaust gas, the method comprising contacting an exhaust gas with the catalyst article according to claim 14.

17. The method for treating an exhaust gas according to claim 16, wherein said method comprises contacting a combustion exhaust gas containing NO_{X} and/or NH₃ with the catalyst article to selectively reduce at least a portion of the N_{X} into N₂ and H₂O and/or oxidize at least a portion of the NH₃.

18. A system for treating an exhaust gas containing NO_{X}, the system comprising a catalyst article according to claim 14 and a source of a reductant, wherein the reductant source is upstream of the catalyst article.
